(19) United States
(12) Patent Application Publication
(10) Pub. No.: US 2008/0078471 A1
(43) Pub. Date: Apr. 3, 2008

(54) Fence assembly with articulating bit guard

(75) Inventor: Michael Richard Hart, Anderson, SC (US)

Correspondence Address: BRINKS HOFER GILSON & LIONE, P.O. BOX 10395, CHICAGO, IL, 60610, US

(73) Assignee: Eastway Fair Company Limited

(21) Appl. No.: 11/540,076

(22) Filed: Sep. 28, 2006

(51) Int. Cl. B25H 1/00; B27M 1/08; B27C 9/00; B27M 1/00

(52) U.S. Cl. 144/371; 144/286.1; 144/286.5

(57) ABSTRACT

A fence assembly with an articulating bit guard is disclosed. The fence assembly with an articulating bit guard preferably includes a workpiece fence, an arm pivotally coupled with the workpiece fence, a slot formed in the arm, and a shield pivotally coupled with the arm at the slot formed in the arm. In operation, as a workpiece is pushed underneath the bit guard, the arm pivots with respect to the workpiece fence, while the shield pivots with respect to the arm as the shield is being raised upward. Further, the pivot point between the shield and the arm is able to slide within a slot provided on the arm, which allows the shield to remain parallel with the workpiece being fed through to engage the power tool.

### BACKGROUND OF THE INVENTION

A combination of a work table and various power tools are commonly used to cut wood workpieces. For example, a power router and router table assembly has the router mounted underneath the table with the router bit facing vertically upward. The router bit extends upward through a hole in the router table and protrudes above the upper surface of the table. Router tables commonly have adjustable workpiece fences on top of the table. The wood workpiece can be slid on the table and along the fence to engage and be cut by the router bit. In addition, some type of guard is commonly provided to protect the operator of the router table from debris or the router bit itself during a cutting operation. However, a common problem with the current guards arises when the workpiece engages the guard as the workpiece is being moved along the fence towards the router bit. Router bit guards in current tables have a lip on the feed side so that the guard slides up when the workpiece is pushed through. This type of guard design tilts up at an angle leaving a space between the workpiece and the guard, which creates a greater risk for the operator to come in contact with the rotating router bit or any debris during a cutting operation. Accordingly, a fence assembly with an articulating bit guard that may overcome these deficiencies is needed.

### BRIEF DESCRIPTION OF THE FIGURES

The invention may be better understood with reference to the following figures and detailed description. The components in the figures are not necessarily to scale, emphasis being placed upon illustrating the principles of the invention.

FIG. 1 is a side view of a fence assembly with an articulating bit guard of a preferred embodiment.

FIG. 1A is a perspective view of a projection that is coupled with a workpiece fence of a preferred embodiment.

FIG. 1B is a perspective view of an alternative projection that is coupled with a workpiece fence.

FIG. 1C is a perspective view of an alternative arm that is coupled with a workpiece fence.

FIG. 2 is a perspective view of an arm and a shield of a preferred embodiment.

FIG. 2A is a perspective view of an alternative arm.

FIG. 3 is a perspective view showing the operation of a fence assembly with an articulating bit guard of a preferred embodiment.

FIG. 3A shows a front view (i.e., from the workpiece feed direction) of a shield of a preferred embodiment.

FIG. 3B shows a front view (i.e., from the workpiece feed direction) of a workpiece engaging a shield of a preferred embodiment.

FIG. 4 is a perspective view of a fence assembly with an articulating bit guard of a preferred embodiment.

### DETAILED DESCRIPTION OF THE PREFERRED EMBODIMENTS

By way of introduction, the preferred embodiments described below include a fence assembly and a method of utilizing the fence assembly. The fence assembly preferably includes a workpiece fence and an articulating bit guard. More particularly the articulating bit guard includes an arm pivotally coupled with the workpiece fence, a slot formed in the arm, and a shield pivotally coupled with the arm at the slot formed in the arm. The phrase “coupled with,” as used herein, means coupled either directly or indirectly via one or more intervening elements. In operation, as a workpiece is pushed underneath the bit guard, the arm pivots with respect to the workpiece fence, while the shield pivots with respect to the arm as the shield is being raised upward. Further, the pivot point between the shield and the arm is able to slide within a slot provided on the arm, which allows the shield to remain parallel with the workpiece being fed through to engage the power tool.

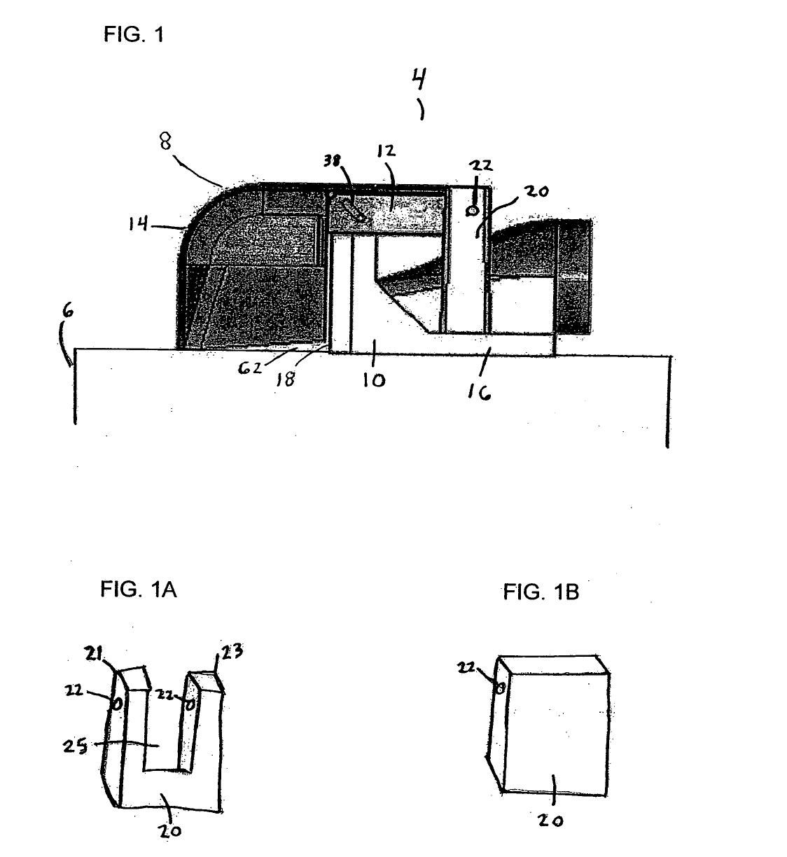

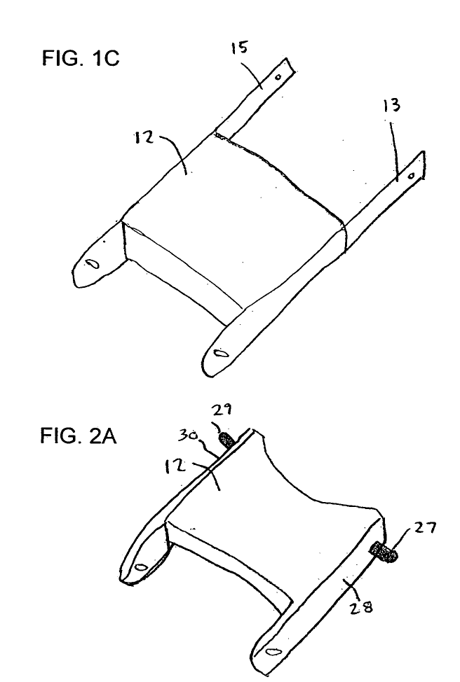

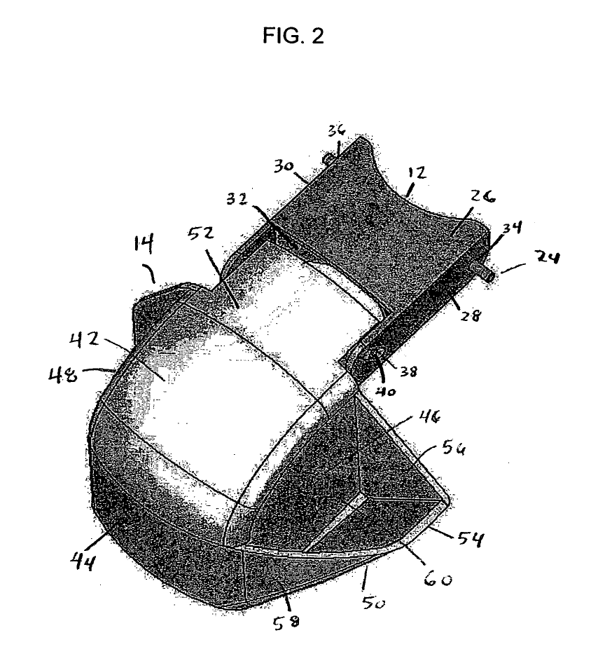

FIG. 1 shows a side view of a preferred embodiment of a fence assembly 4 with an articulating bit guard 8, and FIG. 4 shows a perspective view of a preferred embodiment of a fence assembly 4 with an articulating bit guard 8. The fence assembly 4 generally includes a workpiece fence 10 and an articulating bit guard 8. The articulating bit guard 8 preferably has an arm 12 and a shield 14. The fence assembly 4 with an articulating bit guard 8 of the present invention is constructed to be used with a work table 6. The fence assembly 4 with an articulating bit guard 8 is preferably constructed to be used on a router table during a router cut. However, the fence assembly 4 with an articulating bit guard 8 can also be used in conjunction with the use of other table/power tool combinations, such as a shaper table and shaper tool. The workpiece fence 10 is used for guiding a workpiece during a cutting operation. The workpiece fence 10 is preferably manufactured from aluminum. However, the fence 10 can be manufactured from other types of materials, including steel or plastic. The workpiece fence 10 has a fence base 16 and a fence front 18. Preferably, the fence 10 further includes a projection 20, coupled with the fence base 16, that extends upward from the fence base 16. Alternatively, the projection 20 and the fence base 16 may be formed together as one unitary component of the fence 10. Preferably, the projection 20 is formed in the shape of a U so that the middle portion of the projection 20 consists of empty space 25, as shown in FIG. 1A. The projection 20 is preferably manufactured from aluminum. However, the projection 20 can be manufactured from other types of materials, including steel or plastic. In the configuration shown in FIG. 1A, the projection 20 has an opening 22 formed through the upper portions of each one of its ends 21, 23. Each opening 22 is sized to receive a first pivot pin 24 (as shown in FIG. 2). The first pivot pin 24 couples the arm 12 to the workpiece fence 10. In the preferred embodiment as shown in FIGS. 1 and 1A, the arm 12 is sized so that it is capable of being fitted within the empty space 25 of the projection 20. Alternatively, the projection 20 may be formed as a solid and whole component in the shape of a rectangle, as shown in FIG. 1 B. Alternate shapes, such as square, may be utilized as well. In this configuration, the opening 22 is formed at the upper end of the projection 20 and extends throughout the entire length of the projection 20. When the construction of the projection 20 as shown in FIG. 1 B is utilized, the arm 12 is sized so that the projection 20 can be fitted within the arm 12. Alternatively, the arm 12 can be formed with extensions 13, 15, as shown in FIG. 1C, so that the projection 20 can be fitted between the extensions 13, 15.

FIG. 2 shows a perspective view of the arm 12 and shield 14 of a preferred embodiment of a fence assembly 4 with an articulating bit guard 8. In the preferred embodiment, the arm 12 has a top surface 26 and two side surfaces 28 and 30. The arm 12 is preferably manufactured from plastic. However, the arm 12 can be manufactured from other types of materials, including lightweight metals. The preferable shape of the two side surfaces 28, 30 is rectangular. However, the shape of the side surfaces 28, 30 is not critical, and alternate shapes such as square can be utilized as well. The preferable shape of the top surface 26 of the arm 12 is rectangular. However, the shape of the top surface 26 is not critical, and alternate shapes such as square can be utilized as well. Preferably, the top surface 26 of the arm 12 does not span the entire length of the two side surfaces 28, 30 of the arm 12. Such a construction defines a small opening 32 between the two side surfaces 28, 30 at the front of the arm 12.

In the preferred embodiment, the arm 12 is configured such that the workpiece fence 10 is pivotally coupled with the arm 12 at the rear of the side surfaces 28, 30. Each of the side surfaces 28, 30 of the arm has an opening 34, 36 sized to receive the first pivot pin 24, which allows the arm 12 to rotate about the first pivot pin 24. Preferably, the openings 34, 36 in the side surfaces 28, 30 of the arm 12 are located at the rear of the side surfaces 28, 30. The openings 34, 36 in the side surfaces 28, 30 also preferably correspond with the opening 22 formed in the projection 20 of the workpiece fence 10. Alternatively, rather than the use of the first pivot pin 24 to pivotally couple the arm 12 with the workpiece fence 10, the arm 12 can be formed with pegs 27, 29 on the outside of the side surfaces 28, 30 of the arm 12, as can be seen in FIG. 2A. In an alternative embodiment, the pegs 27, 29 can be formed on the inside of the side surfaces 28, 30 of the arm 12. The pegs 27, 29 are sized to fit within the opening 22 formed in the projection 20 of the workpiece fence 10.

A slot 38 is also provided in each side surface 28, 30 of the arm 12. Although only one slot can be seen in FIG. 2, a slot of the type described below is similarly found in side surface 30 of the arm 12. The slot 38 is preferably located in the side surface 28 at the end opposite that where the opening 34 is located. The slots in the side surfaces 28, 30 of the arm 12 are preferably located such that each slot is aligned parallel with the other slot. The slot 38 is formed to receive a second pivot pin 40, which pivotally couples the arm 12 with the shield 14. The slot 38 is further shaped such that the second pivot pin 40 is capable of sliding within the slot 38. The slot 38 is preferably formed in the shape of a cylinder. The angle of the slot 38 with respect to horizontal can vary between a range of zero degrees to ninety degrees, but is preferred in the range of thirty to sixty degrees, measured with respect to horizontal. In the most preferred embodiment, the slot 38 is configured at an angle of forty-five degrees, measured with respect to horizontal. In the preferred embodiment, horizontal is defined as a plane that is parallel to the worktable.

A safety shield 14 is provided to protect the operator during operation of the power tool. The shield 14 has a top side 42, a front side 44, a right side 46, a left side 48, and a lip 50. Preferably, the top side 42 of the shield 14 includes an extension piece 52. This extension piece 52 is pivotally coupled with the arm 12 using the second pivot pin 40. In alternative embodiments, the shield 14 can be coupled with the arm 12 without the use of an extension piece 52. The shield 14 is preferably manufactured from plastic. However, the shield 14 can be manufactured from other types of materials, including lightweight metals. The shield 14 is also preferably formed from material that is see-through, such as a clear plastic material. The advantage of a see-through shield is that the operator is able to see the workpiece as it engages the power tool. The extension piece 52 is preferably sized such that it is capable of fitting in the opening 32 between the side surfaces 28, 30 of the arm 12. The second pivot pin 40 extends through the extension piece 52 and is secured in both slots 38 formed in the arm 12. The second pivot pin 40 allows the shield 14 to pivot with respect to the arm 12, and it also allows the shield 14 to translate as the second pivot pin 40 slides within the slots 38.

The shield 14 is further configured so that it is capable of allowing a workpiece to be slid underneath the shield 14 during a cutting operation, concurrently lifting the shield 14 upward as the workpiece is being slid underneath. In the preferred embodiment, the right side 46 of the shield 14 is the side that the workpiece is fed through in order for the workpiece to engage the power tool being utilized. To facilitate the lifting of the shield 14, a lip 50 is coupled with or formed at the right side 46 of the shield 14. The lip 50 is preferably comprised of an inclined front surface 54 and two side support surfaces 56, 58. The lip 50 has an inclined front surface 54 that is coupled with the bottom of the right side 46 of the shield 14. Two side support surfaces 56, 58 are also coupled or formed with the right side 46 of the shield and the inclined front surface 54. This configuration of the lip creates a gap 60 between the inclined front surface 54 and the right side 46 of the shield 14. The inclined front surface 54 of the lip 50 is preferably inclined in such a manner that the bottom of the inclined front surface 54 is located closer to the right side 46 of the shield 14 than the top of the inclined front surface 54. The amount of incline manufactured into the inclined front surface 54 of the lip 50 may be varied to allow the shield 14 to engage workpieces of various heights.

As shown in FIG. 1, in the preferred embodiment, the bottom of both the sides of the shield 14 are formed at a slight incline. When the shield 14 is situated in a non-raised position, as shown in FIG. 1, the front of both sides of the shield 14 is in contact with the work table 6, whereas the back of both sides of the shield 14 is not in contact with the worktable 6, creating a small clearance 62 between the shield 14 and the worktable 6. The size of the clearance 62 in the preferred embodiment is three-tenths of an inch.

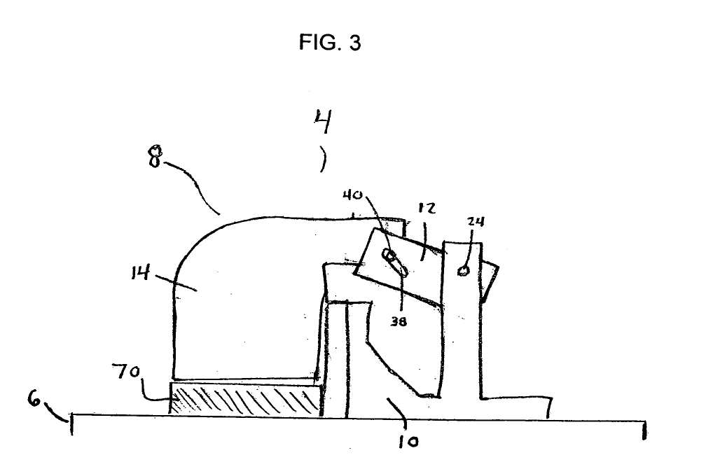

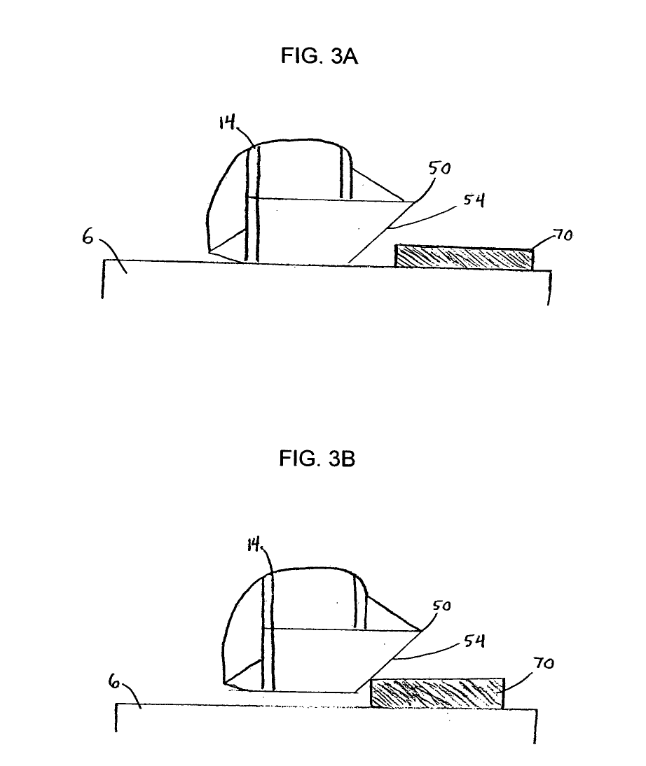

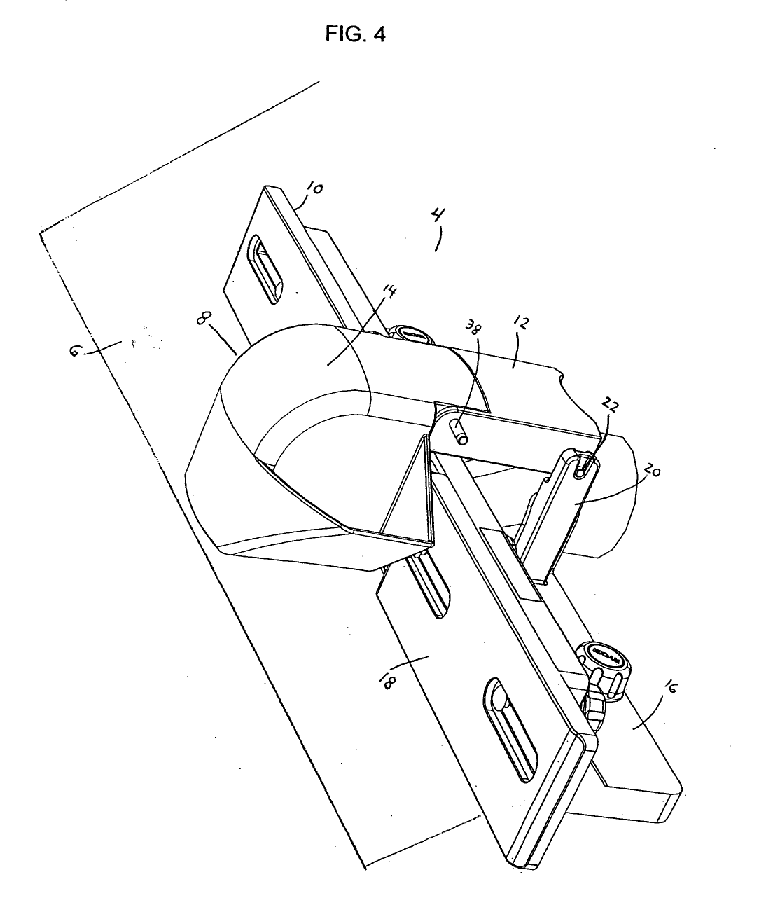

FIGS. 3, 3A, and 3B show the operation of a fence assembly 4 with an articulating bit guard 8 of a preferred embodiment when a workpiece 70 is slid underneath the shield 14. In operation, a workpiece 70 is guided along the workpiece fence 10 toward the power tool cutter, which is being covered by the shield 14. FIGS. 3A and 3B shows the interaction of the lip 50 with a workpiece 70 when the workpiece 70 is slid underneath the shield 14. FIG. 3A shows a front view of the shield 14 before it is engaged by workpiece 70. In this position, the bottom of the shield 14 is substantially parallel with the worktable 6 and workpiece 70. FIG. 3B shows a front view of the shield 14 as workpiece 70 engages the lip 50 of the shield 14. Because the lip 50 is formed with an inclined front surface 54, the workpiece 70 is able to slide underneath the shield 14 while concurrently lifting the shield 14. As the workpiece 70 engages the shield 14, the arm 12 pivots about first pivot pin 24, which concurrently lifts the shield 14 upward. The shield 14 itself will also pivot about second pivot pin 40, where it is coupled with the arm 12. In the preferred embodiment of the invention, the shield 14 is also capable of translating with respect to the arm 12 when the second pivot pin 40 slides in slots 38 formed in arm 12. Because the second pivot pin 40 is capable of sliding within the slots 38, the bottom of the shield 14 remains substantially parallel with the workpiece 70 that is being fed through the shield 14. The shield 14 is similarly capable of remaining substantially parallel with the workpiece 70 as the arm 12 pivots in a downward direction. As is shown in FIG. 3B, the bottom of the shield 14 is able to remain substantially parallel with the workpiece 70, because the shield 14 is able to pivot with respect to the arm 12 and slide within the slots 38 (as described above). Absent the ability of the shield 14 to pivot with respect to the arm 12 and slide within the slots 38, the shield 14 would tilt at an upward angle as the workpiece 70 was being fed through, resulting in a noticeable opening between the shield 14 and the workpiece 70. The ability of the shield 14 to remain substantially parallel with the workpiece 70 prevents any opening from developing between the bottom of the shield 14 and the workpiece 70. This increases the overall safety of a cutting operation, as the risk is decreased that the operator will come into contact with the power tool and any debris will not be able to escape from underneath the shield 14.

Various embodiments of the invention have been described and illustrated. However, the description and illustrations are by way of example only. Many more embodiments and implementations are possible within the scope of this invention and will be apparent to those of ordinary skill in the art. Therefore, the invention is not limited to the specific details, representative embodiments, and illustrated examples in this description. Accordingly, the invention is not to be restricted except in light necessitated by the accompanying claims and their equivalents.

I claim:

1. A fence assembly with an articulating bit guard, comprising:
a workpiece fence,
an arm pivotally coupled with said workpiece fence, said arm including at least one slot, and
a shield pivotally coupled with said arm at said at least one slot.

2. The fence assembly of claim 1, wherein said at least one slot is orientated at an angle between thirty degrees and sixty degrees from horizontal.

3. The fence assembly of claim 1, wherein said articulating bit guard is utilized with a router and router table.

4. The fence assembly of claim 1, wherein said arm is pivotally coupled with said workpiece fence via a first pin.

5. The fence assembly of claim 1, wherein said shield is pivotally coupled with said arm via a second pin capable of being translated within said at least one slot.

6. The fence assembly of claim 1, wherein a front surface of said shield is provided with an inclined lip.

7. The fence assembly of claim 1, wherein said at least one slot is orientated at an angle.

8. The fence assembly of claim 1, wherein said shield is manufactured from a see-through material.

9. A fence assembly with an articulating bit guard, comprising:
a workpiece fence,
an arm with a front end and a rear end, wherein said arm is pivotally coupled with said workpiece fence at said rear end of said arm,
at least one slot formed at an angle in said front end of said arm,
a safety shield for protecting an operator of a power tool pivotally coupled with said at least one slot of said arm via a first pivot pin, wherein said first pivot pin is capable of sliding within said at least one slot of said arm.

10. The fence assembly of claim 9, wherein said at least one slot is orientated at an angle between thirty degrees and sixty degrees from horizontal.

11. The fence assembly of claim 9, wherein said safety shield is manufactured from a see-through material.

12. The fence assembly of claim 9, wherein said arm is pivotally coupled with said workpiece fence via a second pivot pin.

13. The fence assembly of claim 9, wherein a front surface of said safety shield is provided with an inclined lip.

14. The fence assembly of claim 9, wherein said articulating bit guard is utilized with a router and router table.

15. A method of operating a router with a router table, said method comprising:
(a) providing a fence assembly with an articulating bit guard, said fence assembly with an articulating bit guard comprising a workpiece fence, an arm pivotally coupled with said workpiece fence, and a shield pivotally coupled with said arm, wherein said shield is pivotally coupled with said arm in at least one slot provided in said arm via a first pivot pin;
(b) moving a workpiece along said workpiece fence and underneath said shield, wherein said shield is raised upward, said arm pivots at said workpiece fence, said shield pivots at said arm, said first pivot pin slides within said at least one slot, and said shield remains substantially parallel as said workpiece is moved underneath said shield; and
(c) cutting said workpiece with said router.

16. The method according to claim 15, wherein said at least one slot is orientated at an angle between thirty degrees and sixty degrees from horizontal.

17. A router table fence assembly for guiding a workpiece during a router operation comprising a fence and a guard that remains substantially parallel to a work surface as a workpiece is guided along said fence during said router operation.

18. The router table fence assembly of claim 17, wherein said fence assembly further comprises an arm pivotally coupled with said guard.

19. The router table fence assembly of claim 18, wherein said arm includes a slot.

20. The router table fence assembly of claim 17, wherein said guard includes an inclined lip.
